(19) United States
(12) Patent Application Publication
(10) Pub. No.: US 2013/0009488 A1
(43) Pub. Date: Jan. 10, 2013

(54) NON-CONTACT POWER TRANSMISSION DEVICE AND NEAR-FIELD ANTENNA FOR SAME

(75) Inventors: Seong-Hun Choe, Mito (JP); Masatoshi Kanamaru, Inashiki (JP)

(73) Assignee: HITACHI, LTD., Tokyo (JP)

(21) Appl. No.: 13/520,267

(22) PCT Filed: Aug. 27, 2010
(86) PCT No.: PCT/JP2010/064618

§ 371 Date: Jul. 2, 2012

(30) Foreign Application Priority Data
Jan. 6, 2010 (JP) 2010-001254

(51) Int. Cl. H01F 38/14

(52) U.S. Cl. 307/104

(57) ABSTRACT

Disclosed is a structure for raising the Q-value of a near-field antenna used by a non-contact power transmission device that utilizes magnetic field coupling in the near field in a manner improving the efficiency of power transmission. The near-field antenna used by the non-contact power transmission device galvanically isolates a resonant circuit including a resonant first inductor 31 and a first capacitor 32 from a transmission circuit or a reception circuit and, through electromagnetic coupling or inductive coupling established between the transmission or reception circuit and the near-field antenna using a second inductor 33 or a second capacitor 34, maintains a high Q even if the coupling between the antennas weakens due to an extended distance the antennas.

### TECHNICAL FIELD

The present invention relates to a non-contact power transmission device that supplies power to various types of electronic equipment in non-contact system. More particularly, the invention relates to a non-contact power transmission device capable of enhancing the efficiency of power transmission in a non-contact manner through magnetic field coupling in the near field and to a novel near-field antenna for use with that non-contact power transmission device.

### BACKGROUND ART

The devices and schemes for transmitting and receiving power in non-contact system utilize extensively a so-called electromagnetic induction method involving the use of interactions between inductors. Typical applications making use of this electromagnetic induction method, all well-known and already commercialized, include non-contact recharging of electric toothbrushes, electric shavers and portable digital devices; non-contact supply of power to IC cards exemplified by SUICA offered by East Japan Railway Company; and wireless recharging equipment for electric vehicles.

These non-contact power transmission devices generally have the primary coil installed on the side of non-contact power transmission and the secondary coil on the side of non-contact power reception. By applying high-frequency AC power generated within the non-contact power transmission side, the non-contact power transmission device allows a high-frequency magnetic field to be generated on the primary coil or an inductor on the transmission side, thereby causing an induced current to be generated on the secondary coil or an inductor on the reception side. The non-contact power transmission device then accomplishes wireless power transmission by converting high-frequency power induced on the secondary coil into a DC current and supplying the induced DC current to the load on the reception side. A basic configuration of such a non-contact power transmission device has been disclosed in Patent Literature 1 cited below.

Because the above-described non-contact power transmission device permits power transmission through magnetic field coupling in the near field between the transmission-side inductor and the reception-side inductor, these inductors are also called a near-field antenna each. FIG. 12 accompanying this description shows a basic configuration of a prior-art non-contact power transmission device.

As can be seen from FIG. 12, the transmission side of the non-contact power transmission device is configured to be furnished with an AC power source that generates a high frequency, a control circuit that turns on and off the transmission output, and a matching circuit that matches the impedance of an antenna with that of other circuits. This matching circuit is configured to be connected with a near-field antenna for transmitting power. The reception side in FIG. 12 is configured to be furnished with a load that acts as a functional device, a rectification circuit that converts AC power into a DC current, a near-field antenna, and a matching circuit that matches the impedance of an antenna with that of other circuits. This matching circuit is also configured to be connected with a near-field antenna for receiving power.

FIG. 13 accompanying this description shows a detailed configuration of the near-field antennas of the above-described non-contact power transmission device. Specifically, the transmission-side antenna and reception-side antenna have basically the same shape; they are each shaped to be a coil that generates a magnetic field. The transmission-side coil or inductor is directly connected with a transmission circuit comprised of an AC power source, an ON/OFF control circuit, and an impedance matching circuit. Likewise, the reception-side coil or inductor is directly connected with a reception circuit comprised of a load, a rectification circuit, and an impedance matching circuit.

As explained, the non-contact power transmission device disclosed in the above-cited Patent Literature 1 utilizes magnetic field coupling in the near field. The degree of coupling between the inductor of the near-field antenna on the transmission side and the inductor of the near-field antenna on the reception side is given by the coupling coefficient K of the mathematical expression shown below. In this expression, M₁₂ denotes the mutual inductance between the transmission-side inductor and the reception-side inductor, and L₁ and L₂ represent the self-inductance of each of the inductors.

$$K = \frac{{M}_{12}}{\sqrt{{L}_{1} {L}_{2}}} \qquad [ Math . 1 ]$$

As can be seen from the above mathematical expression, the above-mentioned coupling coefficient K is a function of the geometric shapes of the inductors and the distance between the inductors. As the distance between the inductors increases, the coupling coefficient K drops abruptly in inverse proportion to the inductor-to-inductor distance raised to the third power. Thus the prior-art non-contact power transmission device described above has this problem: as the distance between the transmission-side near-field antenna and the reception-side near-field antenna increases, the degree of coupling between the antennas decreases, thereby limiting the distance of non-contact power transmission and reception.

As a countermeasure to the above problem, Non Patent Literature 1 cited below introduces a method for raising the degree of coupling between the transmission-side inductor and the reception-side inductor, both near-field antennas, by optimizing their shapes. Non Patent Literature 1 further discloses a method for extending the distance of power transmission of which the efficiency is improved by the above method.

### CITATION LIST

### Patent Literature

PTL1: Japanese Unexamined Patent Publication No. Hei 11 (1999)-98706

### Non Patent Literature

NPL1: C. M. Zierhofer et al., “Geometric Approach for Coupling Enhancement of Magnetically Coupled Coils,” IEEE Transactions on Biomedical Engineering, Vol. 43, No. 7, July 1996, pp. 708-714

### SUMMARY OF INVENTION

### Technical Problem

However, the methods disclosed in the above-cited Patent Literature 1 and Non Patent Literature 1 still leave the original coupling coefficient dropping in inverse proportion to the coil-to-coil distance raised to the third power, even when the degree of coupling between the transmission-side inductor and the reception-side inductor is elevated. Thus the problem remains that as the distance between the inductors is extended, the efficiency of power transmission abruptly drops, limiting the distance over which power can be transmitted and received in non-contact system.

It is therefore an object of the present invention to overcome the above problem of the prior art and to provide a technique for improving the efficiency of power transmission, as well as a non-contact power transmission device configured to be capable of extending the distance of non-contact power transmission.

### Solution to Problem

In achieving the foregoing object of the present invention, there is provided a non-contact power transmission device using magnetic field coupling in a near field, the non-contact power transmission device including a transmission-side apparatus including at least a high-frequency AC power source and a near-field antenna and transmitting high-frequency power, and a reception-side apparatus including at least a load and a near-field antenna and receiving the high-frequency power transmitted from the transmission-side apparatus. The near-field antenna included in the transmission-side apparatus or in the reception-side apparatus includes a first inductor for resonance, a first capacitor connected with the first inductor to adjust an oscillating frequency, and a coupling means formed in a manner faradically isolated from a resonant circuit including the first inductor and the first capacitor, the coupling means supplying AC power from the high-frequency AC power source of the transmission-side apparatus to the resonant circuit including the first inductor and the first capacitor, the coupling means further supplying alternatively the high-frequency power received by the resonant circuit including the first inductor and the first capacitor to the load of the reception-side apparatus.

With the non-contact power transmission device according to the present invention, the coupling means may preferably be constituted by a second inductor coupled electromagnetically with the first inductor for resonance. Also, the second inductor constituting the coupling means may preferably be formed with electrodes made of thin metallic films over the same dielectric substrate along with the first inductor constituting the resonant circuit and the first capacitor for adjusting the oscillating frequency. Further, the second inductor constituting the coupling means may preferably be formed outside the first inductor and the first capacitor may preferably be positioned inside the first inductor over the same dielectric substrate. Alternatively, the second inductor constituting the coupling means may preferably be formed inside the first inductor and the first capacitor may preferably be positioned outside the inductor over the same dielectric substrate.

Furthermore, in achieving also the foregoing object of the present invention, the above-outlined non-contact power transmission device may preferably have the coupling means constituted by a second capacitor coupled electromagnetically with the first inductor for resonance. Moreover, the second capacitor constituting the coupling means may preferably be formed on one side of the same dielectric substrate and the first capacitor may preferably be formed on the other side of the same dielectric substrate, the second capacitor and the first capacitor being positioned in close proximity to each other. And electrodes positioned on both sides of the same dielectric substrate in close proximity to one another may preferably be partially made of comb-tooth electrodes to form the first capacitor and the second capacitor constituting the coupling means.

### Advantageous Effects of Invention

As described above, according to the non-contact power transmission device or the near-field antenna thereof of the present invention, separating the transmission and reception circuits from the near-field antennas contributes to raising the Q-value of the antennas. As a result, even if the distance between the two antennas is extended and the degree of coupling between the resonance-use inductors of the transmitting and receiving antennas is lowered thereby, it is possible to provide higher efficiency of power transmission and a longer distance of power transmission than prior-art non-contact power transmission systems.

### BRIEF DESCRIPTION OF DRAWINGS

FIG. 1 is a block diagram showing a configuration of a non-contact power transmission device using the magnetic field in the near field according to the present invention.

FIG. 2 is a plan view showing a theoretical configuration of a near-field antenna for the non-contact power transmission device as example 1 of the present invention.

FIG. 3 is a perspective view showing a detailed configuration of the near-field antenna as the example 1.

FIG. 4 is a circuit diagram showing a circuit configuration of a non-contact power transmission device utilizing the near-field antenna as the example 1.

FIG. 5 is a plan view showing a theoretical configuration of a near-field antenna for the non-contact power transmission device as example 2 of the present invention.

FIG. 6 is a perspective view showing a detailed configuration of the near-field antenna as the example 2.

FIG. 7 is a plan view showing a theoretical configuration of a near-field antenna for the non-contact power transmission device as example 3 of the present invention.

FIG. 8 is a perspective view showing a detailed configuration of the near-field antenna as the example 3.

FIG. 9 is a circuit diagram showing a circuit configuration of a non-contact power transmission device utilizing the near-field antenna as the example 3.

FIG. 10 is a graphic representation comparing the non-contact power transmission device of the present invention with a prior-art non-contact power transmission device in terms of power transmission efficiency.

FIG. 11 is a graphic representation showing changes in the ratio of power transmission efficiency between the inventive non-contact power transmission device and the prior-art non-contact power transmission device with regard to normalized distances.

FIG. 12 is a plan view showing a configuration of a near-field antenna for the prior-art non-contact power transmission device.

FIG. 13 is a circuit diagram showing a circuit configuration of a non-contact power transmission device utilizing the above-mentioned prior-art near-field antenna.

### DESCRIPTION OF EMBODIMENTS

Some examples of the present invention will be described below in detail by reference to the accompanying drawings.

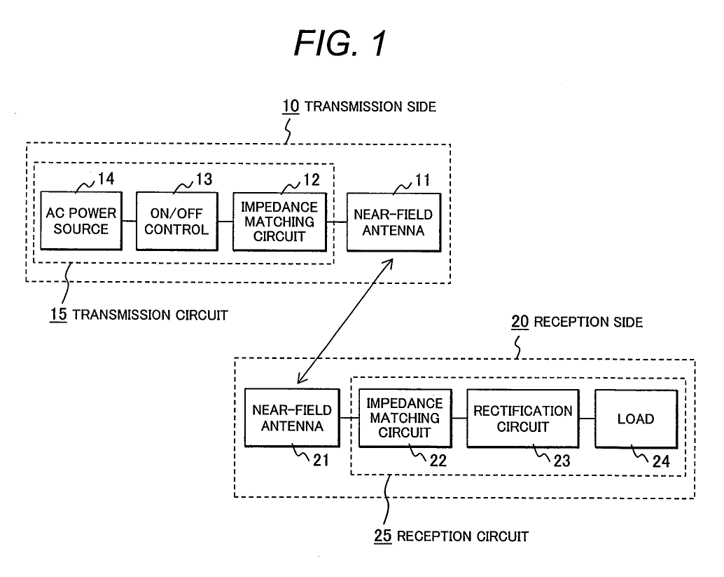

FIG. 1 accompanying this description shows a configuration of a non-contact power transmission device according to the present invention. In FIG. 1, a transmission side 10 includes an AC power source 14 that generates a high frequency, an ON/OFF control circuit 13 that turns on and off transmission output, and an impedance matching circuit 12 that matches the impedance of an antenna with that of the other circuits. These components make up a so-called a transmission circuit 15. This transmission circuit 15, particularly the output of its impedance matching circuit 12, is connected to a near-field antenna 11 for transmitting power.

On the other hand, the reception side in FIG. 1 includes a load 24 that acts as a functional device, a rectification circuit 23 that converts AC power into DC power and supplies the DC power to the load 24, and an impedance matching circuit 22 that matches the impedance of a near-field antenna with that of the other circuits. These components make up a so-called reception circuit 25. This reception circuit 25, particularly the input of its impedance matching circuit 22, is connected to a near-field antenna 21 for receiving power.

Below is a description of a near-field antenna used by the non-contact power transmission device of the present invention, in comparison to the near-field antenna used by a common non-contact power transmission system.

### <Near-Field Antennas for the Prior-Art Non-Contact Power Transmission System>

A common non-contact power transmission system usually has a capacitor connected to each of a transmission-side inductor and a reception-side inductor, and causes these capacitors to operate at a resonant frequency in order to maximize the efficiency of power transmission. In this configuration, the capacitors play the role of synchronizing the frequency of the transmission-side inductor with that of the reception-side inductor.

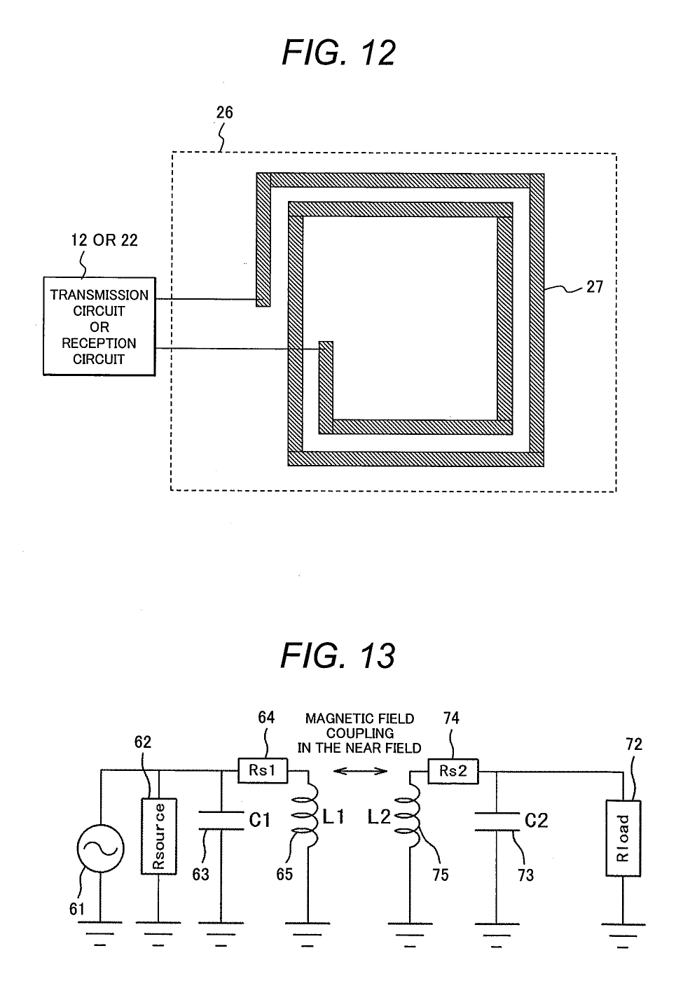

FIG. 12 accompanying this description shows a typical configuration of a near-field antenna for use by the above-outlined common non-contact power transmission system. Basically, this near-field antenna has the same shape and the same structure on both the transmission side and the reception side, and constitutes a coil for generating a magnetic field. That is, a transmission-side coil or an inductor 27 is formed spirally over the surface of a substrate 26.

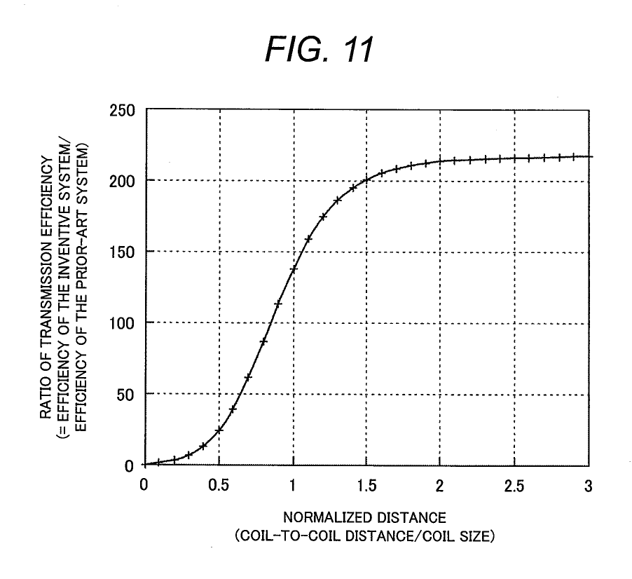

FIG. 13 accompanying this description shows a typical electrical circuit of a non-contact power transmission system that uses the above-outlined near-field antennas. In FIG. 13, the transmission side includes a high-frequency source (Source) 61 that generates a high frequency, and a resistance (R source) 64 that represents the impedance of the transmission circuit. Further, the near-field antenna for transmitting power is constituted by an inductor (L1) 65, a capacitor (C1) 63 for frequency adjustment, and an internal resistance (Rs 1) 64 stemming from the antenna wiring. On the other hand, the reception side in FIG. 11 includes a load as a functional device and a resistance (R load) 72 representing the impedance of the reception circuit. Moreover, the near-field antenna for receiving power is constituted by an inductor (L2) 75, a capacitor (C2) 73 for frequency adjustment, and an internal resistance (Rs2) 74 stemming from the antenna wiring. The resonant frequency of this circuit is given by the mathematical expression shown below. In this expression, f denotes the resonant frequency; L1 stands for the inductance of the inductor on the transmission side and L2 for the inductance of the inductor on the reception side; and C1 stands for the capacitance of the capacitor on the transmission side and C2 for the capacitance of the capacitor on the reception side.

$$f = \frac{1}{2 π} \sqrt{\frac{1}{{L}_{1 , 2} {C}_{1 , 2}}} \qquad [ Math . 2 ]$$

The efficiency of energy transmission with a conventional resonance system is affected by the Q-value of the resonance system. That is, a higher Q-value increases the reactance energy accumulated in the resonance system, and represents the characteristic of high transmission efficiency over a narrow band. On the other hand, a lower Q-value increases the energy consumed by the resistance as opposed to the reactance energy, and represents the characteristic of low transmission efficiency over a wide band. Also with the above-mentioned non-contact power transmission system and non-contact power transmission method, the efficiency of power transmission is affected not only by the degree of coupling between the inductors described above but also by the Q-value of the antennas on the transmission and reception sides. For this reason, a non-contact power transmission system having antennas of a high Q-value manifests the characteristic of high power transmission efficiency.

The Q-value of the antenna parts is given by the mathematical expression shown below. In this expression f stands for frequency, L for the inductance of the antennas, and R for the resistance of the antenna parts.

$$Q = \frac{( 2 π f ) L}{R} \qquad [ Math . 3 ]$$

As can be seen from the above mathematical expression, in the common non-contact power transmission system of which the electrical circuit is shown in FIG. 13, the transmission and reception circuit parts are directly connected to the antenna parts. For this reason, the impedance of the transmission and reception circuits appears as the resistance in the above mathematical expression, which contributes to lowering the Q-value of the antennas. Consequently, the system turns out to be a resonance system with a poor resonance characteristic and gives a reason for lowering the efficiency of power transmission. Thus the inventors of this invention concluded that the lowered Q-value mentioned above constitutes a cause for limiting the distance of power transmission.

The present invention has been made in view of the above-described results of the inventors' examination. This invention has thus been brought about on the findings that even if the distance between the inductors is extended and the degree of coupling therebetween is lowered accordingly, the overall efficiency of power transmission of a non-contact power transmission system can be improved as long as an elevated Q-value of the antennas is maintained.

### <Principles of Non-Contact Power Transmission of the Present Invention>

The non-contact power transmission system thus implemented according to this invention has a first inductor for resonance and a second inductor coupled with the first inductor as the near-field antennas for transmission and reception, the inductors being formed over the same substrate. Further, the first inductor is connected with a capacitor for frequency adjustment in order to achieve resonant frequency synchronization. The second inductor exchanges power with the first inductor through electromagnetic inductance generated therebetween, and the second inductor is directly connected with the transmission circuit or reception circuit. That is, the first inductor is isolated galvanically from the above-mentioned transmission circuit or reception circuit.

The near-field antenna of the present invention, configured using the first inductor for resonance and the second inductor for coupling, is thus isolated galvanically from the transmission circuit and reception circuit, compared with the near-field antenna of the above-mentioned common non-contact power transmission system. For this reason, the impedance of the transmission and reception circuits does not directly affect the Q of the inventive antenna. The Q of the near-field antenna can thus be kept high. Consequently, a high level of transmission efficiency is brought about between the transmitting antenna and the receiving antenna.

In addition, the inventive near-field antenna configured using the first inductor for resonance and the second inductor for coupling is formed on the sample plane across which the vertical distance between the inductors is zero (0). This makes it possible to raise the degree of electromagnetic induction coupling between the two inductors and to implement high transmission efficiency therebetween.

And the efficiency of transmission with the near-field antenna of the present invention is expressed as the product of the efficiency of transmission between the first inductor for resonance and the second inductor for coupling on the transmission side, of the efficiency of transmission between the first inductor for resonance and the second inductor for coupling on the reception side, and of the efficiency of transmission between the resonance coils of the near-field antenna on the reception side.

Thus in the configuration of the near-field antenna of the present invention, the antenna for the common non-contact power transmission system is separated galvanically between the inductor for resonance and the inductor for coupling so as to maintain a high Q of the near-field antenna. As a result, even if the distance between the two antennas is extended and the degree of coupling between the inductors for resonance of the transmitting and receiving antennas is lowered accordingly, it is possible to bring about higher efficiency of power transmission than with the common non-contact power transmission system. Consequently the distance of transmission can be extended.

### Example 1

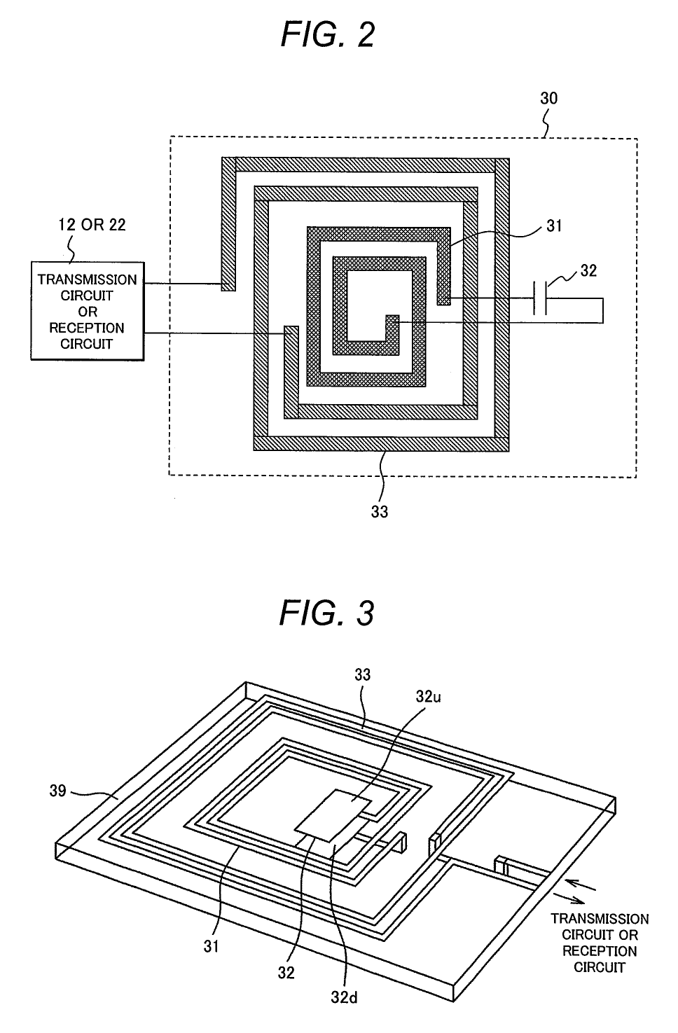

FIG. 2 accompanying this description shows a theoretical configuration of a near-field antenna for non-contact power transmission as example 1 of the present invention. In FIG. 2, a first inductor 31 for resonance and a second inductor 33 coupled with the first inductor are formed over the same substrate 30. Between both ends of the first inductor 31, a capacitor 32 for frequency adjustment is connected interposingly. And the transmission circuit or reception circuit is connected to both ends of the second inductor. In the configuration of the example 1, the first inductor 31 is positioned inside the second inductor 33 over the same substrate 30. The two inductors exchange energy therebetween through a high degree of electromagnetic induction coupling.

FIG. 3 accompanying this description is a perspective view of the above-described near-field antenna for non-contact power transmission as the example 1. The first inductor 31 and second inductor 33, both made of thin metallic films, are formed over the substrate 30 composed of a dielectric material. The material of the dielectric substrate can be made of FR-4, a ceramic substrate, a glass substrate, or a high-resistance silicon, for example.

As can be seen from FIG. 3, the first inductor 31 and the second inductor 33 are formed over the surface of the dielectric substrate 30. Also, the first inductor 31 is formed along the outer periphery of the substrate 30 and the second inductor 33 is formed inside the first inductor 31. Further, at the approximate center of the substrate 30, a pair of electrode plates 32ᵤ and 32_{d} positioned with the dielectric substrate 30 interposed therebetween (i.e., on both sides of the substrate) make up a capacitor 32. The capacitor 32 is connected to both ends of the first inductor 31 as explained above, by way of conductors formed on both sides of and through the substrate. The capacitor 32 is provided for resonant frequency synchronization. In the example of FIG. 3, the capacitor is constituted as a so-called parallel plate type capacitor using electrodes formed on both sides of the dielectric substrate in a manner opposite to each other across the substrate. However, the capacitor is not limited to the illustrated example; it may alternatively be a chip capacitor that can be mounted on the surface of the dielectric substrate 30, or a variable capacitor having the capability of frequency modulation. In particular, the example 1 configured to have the capacitor 32 positioned inside the first inductor 31 at the approximate center of the substrate 30 makes it possible to constitute the entire near-field antenna in smaller dimensions than before.

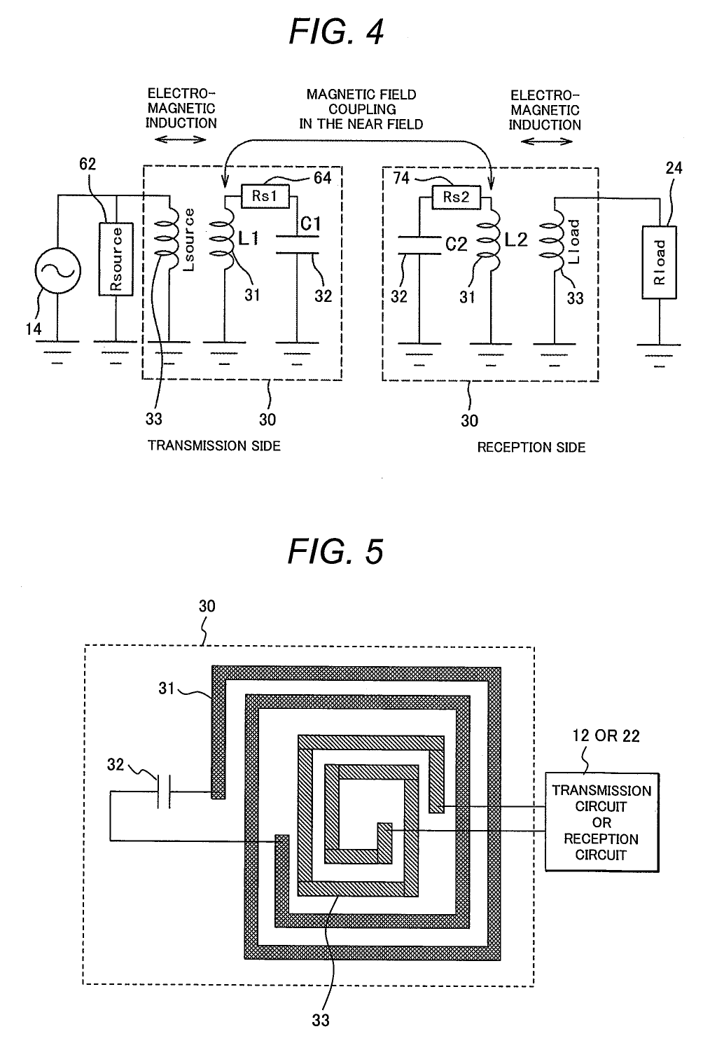

FIG. 4 shows an electrical circuit of a non-contact power transmission device utilizing the above-described example 1 of this invention. As can be seen from FIG. 4, on the transmission side, the first inductor 31 (L1) constituting the near-field antenna is isolated galvanically from the transmission circuit. The transmission circuit includes an AC power source 14 that generates a high frequency, and has the impedance (R source) 62 of a transmission circuit that contains the AC power source 14 and the inductance (L source) of the coupling inductor 33. The high frequency from the AC power source is transmitted from the second inductor 33 (L source) to the first inductor 31 (L1) through electromagnetic induction. The near-field antenna for transmitting power is constituted by the first inductor 31 (L1) as the resonance inductor, by the capacitor (C1) 32 for frequency adjustment, and by an internal resistance (Rs 1) 64 stemming from the near-field antenna wiring.

Also on the reception side, the first inductor 31 (L1) constituting the near-field antenna is isolated galvanically from the reception circuit. The reception circuit includes the load 24 as a functional device indicated as an impedance (R load), and an inductance (L load) of the coupling inductance 33. And the reception-side near-field antenna for receiving power from the transmission side is constituted as explained above by the first inductor 31 (L2) as the resonance inductor, by a capacitor (C2) for frequency adjustment, and by an internal resistance (Rs 2) stemming from the near-field antenna wiring.

Thus the non-contact power transmission device of the present invention in particular has its near-field antenna isolated galvanically from the transmission circuit or from the reception circuit unlike the common non-contact power transmission device. This makes it possible to maintain a high Q-value of the near-field antenna. And as illustrated, the non-contact power transmission device of this invention carries out power transmission in three stages, to be explained below.

First of all (1), on the transmission side, power transmission takes place between the coupling inductor 33 with a high degree of coupling and the resonance inductor 31. Next (2), power transmission is carried out through near-field magnetic field coupling between the first inductor 31 (L1) as the transmission-side antenna and the first inductor 31 (L2) as the reception-side antenna, both antennas having a high Q each. And finally (3), on the reception side, power transmission is brought about between the resonance inductor 31 and the coupling inductor 33 having a high degree of coupling therebetween. For this reason, the efficiency of power transmission with the non-contact power transmission device of this invention is represented by the product of the levels of transmission efficiency in the above-described three stages. In each stage, power transmission is carried out under conditions of high transmission efficiency, so that the inventive non-contact power transmission device provides higher efficiency of power transmission than the prior-art non-contact power transmission device having a low Q. In other words, it is possible to maintain a high Q even if the distance between the antennas is extended and the degree of coupling therebetween is lowered accordingly.

### Example 2

Next, FIG. 5 shows a theoretical configuration of a near-field antenna for non-contact power transmission as example 2 of the present invention. In the example 2, as in the example 1, the first inductor 31 for resonance and the second inductor 33 coupled with the first inductor are formed over the same substrate 30 made of a dielectric material. However, unlike the example 1, the example 2 has the first inductor 31 positioned outside the second inductor 33 over the same substrate 30. The two inductors exchange energy therebetween through a high degree of electromagnetic induction coupling. Also in the example 2, the capacitor 32 for frequency adjustment is connected to the first inductor 31, and the above-mentioned transmission circuit or reception circuit is connected to the second inductor 33.

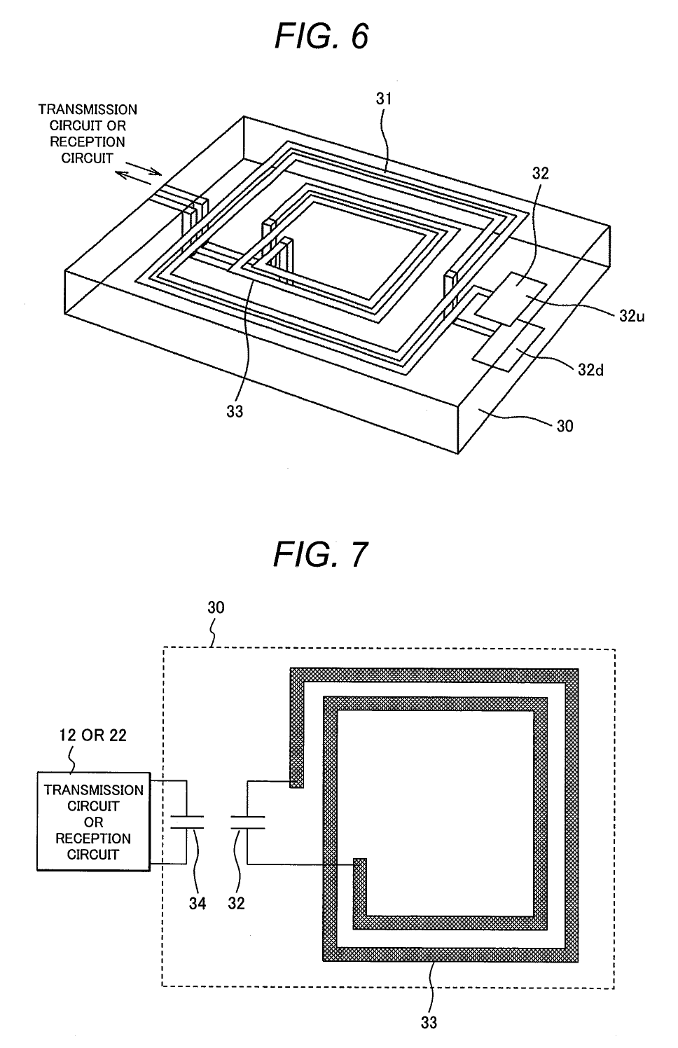

FIG. 6 is a perspective view of the near-field antenna for non-contact power transmission as the above-described example 2. The first inductor and the second inductor, both made of a metallic material, are formed over the dielectric substrate. Also in the example 2, the material of the dielectric substrate 30 can be made of FR-4, a ceramic substrate, a glass substrate, or a high-resistance silicon, for example. And as can be seen from FIG. 6, the first inductor 31 and the second inductor 33 are formed over the surface of the dielectric substrate 30, and the first inductor 31 is positioned inside the second inductor 33. The above-mentioned capacitor 32 for resonant frequency synchronization is attached to the first inductor 31. In the example 2, at an edge of the dielectric substrate 30, the capacitor 32 is formed by a pair of electrode plates 32_{U} and 32_{D} with the dielectric substrate 30 interposed therebetween (i.e., on both sides of the substrate). The capacitor 32 is connected to both ends of the first inductor 31 as explained above, by way of conductors formed on both sides of and through the substrate. The capacitor is not limited to the illustrated example; it may alternatively be a chip capacitor that can be mounted over the surface of the dielectric substrate 30, or a variable capacitor having the capability of frequency modulation.

The near-field antenna of the above-described configuration for non-contact power transmission as the example 2 of this invention has the same workings and offers the same effects as the example 1 discussed above. And the non-contact power transmission device of the example 2 also provides power transmission in three stages as discussed above. The efficiency of transmission with this non-contact power transmission device is also represented by the product of the levels of transmission efficiency in the three stages. This makes it possible for the inventive non-contact power transmission device to bring about a higher level of power transmission efficiency than the prior-art non-contact power transmission device having a low Q. That is, even if the distance between the antennas is extended and the degree of coupling therebetween is lowered accordingly, it is possible to maintain a high Q.

### Example 3

Next, FIG. 7 accompanying this description shows a theoretical configuration of a near-field antenna for non-contact power transmission as example 3 of the present invention. That is, in the example 3, the first inductor 31 for resonance is formed over the same dielectric substrate 30, with both ends of the inductor 31 connected to the capacitor 32 for frequency adjustment. Unlike the above-described example 1 or 2, the example 3 has a second capacitor 34 positioned adjacent to the (first) capacitor 32 for frequency adjustment without the second inductor being formed over the same substrate 30. The second capacitor 34 is connected to the transmission circuit or reception circuit.

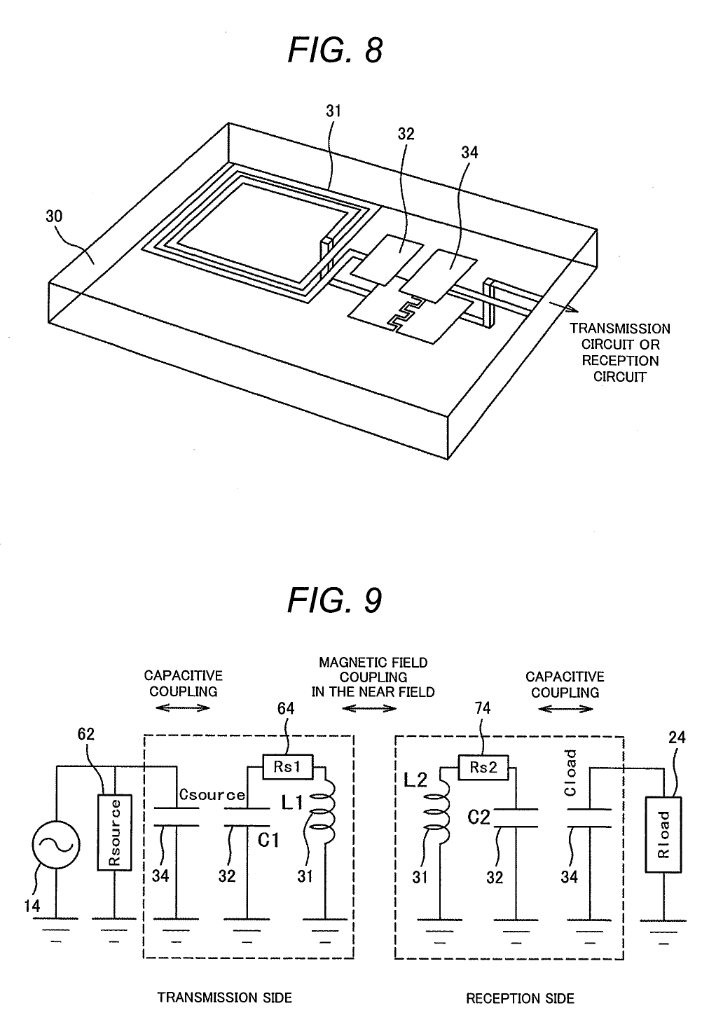

FIG. 8 accompanying this description is a perspective view of the above-described near-field antenna for non-contact power transmission. As can be seen from this perspective view, the first capacitor 32 and the second capacitor 34 are positioned in close proximity to each other along with the first inductor 31 made of a metallic material over the dielectric substrate 30. More specifically, the capacitors 33 and 34 are formed by a pair of electrode plates 32ᵤ and 32_{d} by a pair of electrode plates 34ᵤ and 34_{d}, respectively, on both sides of the dielectric substrate 30 whose material is typically FR-4, a ceramic substrate, a glass substrate or a high-resistance silicon, the capacitors 32 and 34 being positioned in close proximity to each other. The first capacitor 32 and the second capacitor 34 are each constituted as a so-called parallel plate type capacitor using electrodes formed with the dielectric substrate 30 interposed therebetween.

And the electrode plates 32ᵤ and 32_{d} and the electrode plates 34ᵤ and 34_{d} are positioned on both sides of the dielectric substrate 30 in close proximity to one another with the substrate 30 interposed therebetween. For this reason, the first capacitor 32 and the second capacitor 34 are coupled capacitively. That is, in the case of the near-field antenna of the example 3 of this invention, the first capacitor 32 and the second capacitor 34 exchange energy through a high degree of capacitive coupling therebetween. In the example 3, as shown in FIG. 8, the electrode plate 32_{d} of the first capacitor 32 and the electrode plate 34_{d} of the second capacitor 34 on the bottom (back) side of the dielectric substrate 30 are formed as comb-tooth electrodes of which the concave and convex portions are opposed in a manner alternately engaged with one another, whereby a high degree of capacitive coupling is ensured between the first capacitor 32 and the second capacitor 34. In addition to the above-described use of comb-tooth electrodes, there are many other ways available to establish capacitive coupling between the first capacitor and the second capacitor, and any one of them may be adopted.

FIG. 9 accompanying this description shows an electrical circuit of a non-contact power transmission device utilizing the near-field antenna as the above-described example 3 of this invention. As can be seen from FIG. 9, on the transmission side, the first inductor 31 (L1) constituting the near-field antenna is isolated galvanically from the transmission circuit that includes the AC power source 14. However, the high frequency from the AC power source 14 is transmitted to the first inductor 31 (L1) through the above-described high degree of capacitive coupling between the first capacitor 32 and the second capacitor 34. In FIG. 9, the impedance (R source) of the transmission circuit on the transmission side is indicated by reference numeral 62, and the second capacitor 34 serving as the coupling capacitor is represented by a capacitance (C_source). And the near-field antenna for transmitting power is constituted by a resonance inductor (L1), by a capacitor (C1) for frequency adjustment, and by an internal resistance (Rs 1) stemming from the near-field antenna wiring.

On the reception side, in like manner as described above, the reception circuit is isolated galvanically from the near-field antenna. In the reception circuit, the load 24 including a functional device is represented by an impedance (R load). The coupling capacitor (second capacitor) 34 in the reception circuit possesses a capacitance (C_load). And the near-field antenna (first antenna) 31 for receiving power from the above-mentioned transmission side is constituted by the inductance (L2) of the resonance inductor, by the capacitance (C2) of the capacitor for frequency adjustment, and by an internal resistance (Rs 2) stemming from the near-field antenna wiring.

Thus compared with the common non-contact power transmission device, the non-contact power transmission device using the near-field antenna of the example 3 has the transmission circuit or the reception circuit isolated galvanically from the near-field antenna through capacitive coupling, making it possible to maintain a high Q-value of the transmitting and receiving antennas. This allows the non-contact power transmission device of the present invention to bring about higher transmission efficiency than the prior-art non-contact power transmission system having a low Q-value. That is, even if the distance between the antennas is extended and the degree of coupling therebetween is lowered accordingly, a high Q can be maintained.

As is clear from the configurations shown in FIGS. 7 and 8, the near-field antenna of the above-described example 3 of this invention need only have the first inductor 31 formed over the dielectric substrate 30 as a spiral-shaped coil. For this reason, the example 3 is easier to manufacture than the above-described examples 1 and 2. It is also possible to make the entire device (substrate) of the example 3 smaller in shape than the other examples.

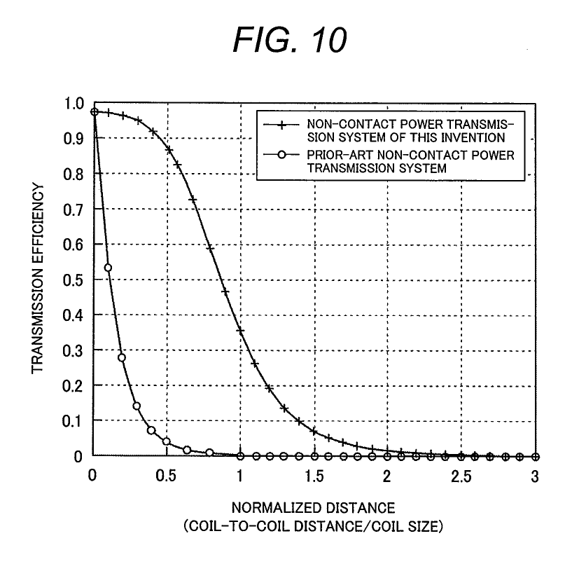

Furthermore, the graphic representation of FIG. 10 accompanying this description shows a comparison in power transmission efficiency between the non-contact power transmission system of this invention and the prior-art non-contact power transmission device. The size of the coils used on non-contact IC cards such as SUICA offered by East Japan Railway Company was applied to calculating the levels of transmission efficiency. Also, the coil size was assumed to be the same as that of the inductor (inductor size: 70×40 mm ̂2; inductor width: 1 mm; inductor turn count: 1; inductor material: lossless metal), and the distance between the inductors with regard to the inductor size was defined as the normalized distance varied from “0” to “3” in calculating the levels of transmission efficiency.

Under the above-described conditions, the inductance of the inductors was 0.14 μH. Where a 10-pF capacitor was connected in series, the resonant frequency was 42 MHz. When the internal resistance of the near-field antenna was brought to 1Ω, the Q-value of the prior-art non-contact power transmission device was 2.5 while the Q-value of the non-contact power transmission device of this invention was 37.3. That is, the Q-value was improved about 15-fold.

Also, when the practical level of the efficiency of non-contact power transmission was set to 0.5, for example, the normalized distance with the prior-art non-contact power transmission device remained at about 0.1 while the normalized distance with the non-contact power transmission device of this invention could be extended to about 0.9. These findings confirmed that the inventive device is capable of significantly improving the efficiency of transmission.

Lastly, FIG. 11 accompanying this description shows changes in the ratio of power transmission efficiency between the inventive non-contact power transmission device and the prior-art non-contact power transmission device (=efficiency of the inventive system/efficiency of the prior-art system). That is, as can be seen from the curve in the figure, where the normalized distance is “0” on the horizontal axis, the ratio of transmission efficiency between both devices is about “1” (approximately equal). However, as the distance is extended, the ratio of transmission efficiency is improved significantly. When the normalized distance is later brought to “1.5” or longer, the ratio is confirmed to be stable at about “220.” This result means that if the antenna of the non-contact power transmission device according to this invention is adopted, the efficiency of transmission is improved 220-fold compared with the prior-art non-contact power transmission device. That is, even if the distance between the antennas is extended and the degree of coupling therebetween is lowered accordingly, it is possible to maintain a high Q.

### REFERENCE SIGNS LIST

10 Transmission side of non-contact power transmission device
11 Near-field antenna on transmission side
12 Impedance matching circuit
13 ON/OFF control circuit for power transmission
14 High-frequency AC power source
15 Transmission circuit
20 Reception side of non-contact power transmission device
21 Near-field antenna on reception side
22 Impedance matching circuit
23 Rectification circuit
24 Load
25 Reception circuit
30 Dielectric substrate
31 First inductor for resonance
32 First capacitor for frequency adjustment
33 Second inductor for coupling
34 Second capacitor for capacitive coupling

1. A non-contact power transmission device using magnetic field coupling in a near field, comprising:
a transmission-side apparatus including at least a high-frequency AC power source and a near-field antenna and transmitting high-frequency power; and
a reception-side apparatus including at least a load and a near-field antenna and receiving the high-frequency power transmitted from the transmission-side apparatus,
wherein the near-field antenna included in the transmission-side apparatus or in the reception-side apparatus includes:
a first inductor for resonance;
a first capacitor connected with the first inductor to adjust an oscillating frequency; and
a coupling means formed in a manner faradically isolated from a resonant circuit including the first inductor and the first capacitor, the coupling means supplying AC power from the high-frequency AC power source of the transmission-side apparatus to the resonant circuit including the first inductor and the first capacitor, the coupling means further supplying alternatively the high-frequency power received by the resonant circuit including the first inductor and the first capacitor to the load of the reception-side apparatus.

2. The non-contact power transmission device according to claim 1, wherein the coupling means is constituted by a second inductor coupled electromagnetically with the first inductor for resonance.

3. The non-contact power transmission device according to claim 2, wherein the second inductor constituting the coupling means is formed with electrodes made of thin metallic films over the same dielectric substrate along with the first inductor constituting the resonant circuit and the first capacitor for adjusting the oscillating frequency.

4. The non-contact power transmission device according to claim 3, wherein the second inductor constituting the coupling means is formed outside the first inductor and the first capacitor is positioned inside the first inductor over the same dielectric substrate.

5. The non-contact power transmission device according to claim 3, wherein the second inductor constituting the coupling means is formed inside the first inductor and the first capacitor is positioned outside the inductor over the same dielectric substrate.

6. The non-contact power transmission device according to claim 1, wherein the coupling means is constituted by a second capacitor coupled electromagnetically with the first inductor for resonance.

7. The non-contact power transmission device according to claim 6, wherein the second capacitor constituting the coupling means is formed on one side of the same dielectric substrate and the first capacitor is formed on the other side of the same dielectric substrate, the second capacitor and the first capacitor being positioned in close proximity to each other.

8. The non-contact power transmission device according to claim 7, wherein electrodes positioned on both sides of the same dielectric substrate in close proximity to one another are partially made of comb-tooth electrodes to form the first capacitor and the second capacitor constituting the coupling means.

9. A near-field antenna included in a transmission-side apparatus or a reception-side apparatus of a non-contact power transmission device using magnetic field coupling in a near field, the near-field antenna comprising:
a first inductor for resonance;
a first capacitor connected with the first inductor to adjust an oscillating frequency; and
a coupling means isolated faradically from a resonant circuit including the first inductor and the first capacitor, the coupling means supplying AC power from the outside to the resonant circuit including the first inductor and the first capacitor, the coupling means further supplying alternatively received high-frequency power to the outside.

10. The near-field antenna according to claim 9, wherein the coupling means is constituted by a second inductor coupled electromagnetically with the first inductor for resonance.

11. The near-field antenna according to claim 10, wherein the second inductor constituting the coupling means is formed with electrodes made of thin metallic films over the same dielectric substrate along with the first inductor constituting the resonant circuit and the first capacitor for adjusting the oscillating frequency.

12. The near-field antenna according to claim 11, wherein the second inductor constituting the coupling means is formed outside the first inductor and the first capacitor is positioned inside the first inductor over the same dielectric substrate.

13. The near-field antenna according to claim 11, wherein the second inductor constituting the coupling means is formed inside the first inductor and the first capacitor is positioned outside the inductor over the same dielectric substrate.

14. The near-field antenna according to claim 9, wherein the coupling means is constituted by a second capacitor coupled electromagnetically with the first inductor for resonance.

15. The near-field antenna according to claim 14, wherein the second capacitor constituting the coupling means is formed on one side of the same dielectric substrate and the first capacitor is formed on the other side of the same dielectric substrate, the second capacitor and the first capacitor being positioned in close proximity to each other.

16. The near-field antenna according to claim 15, wherein electrodes positioned on both sides of the same dielectric substrate in close proximity to one another are partially made of comb-tooth electrodes to form the first capacitor and the second capacitor constituting the coupling means.
